(19) United States
(12) Patent Application Publication
(10) Pub. No.: US 2015/0374008 A1
(43) Pub. Date: Dec. 31, 2015

(54) CONFECTIONERY PRODUCT

(71) Applicant: Alexander Rafailovich AVALOV, Moscow (RU)

(72) Inventor: Alexander Rafailovich AVALOV, Moscow (RU)

(21) Appl. No.: 14/407,433

(22) PCT Filed: Jun. 17, 2013
(86) PCT No.: PCT/RU2013/000489

§ 371 Date: Dec. 11, 2014

(30) Foreign Application Priority Data
Jun. 19, 2012 (RU) 2012125227

(51) Int. Cl. A23G 3/48; A23G 3/42

(52) U.S. Cl. CPC A23G 3/48; A23G 3/42; A23V 2002/00

(57) ABSTRACT

A confectionery product consisting of a molded glazed shell containing natural honey, grinded dried apricots, dried prune, walnut and dried cranberry. The components of the homogeneous mass of the product are taken in the following ratio, percentage by weight: 24.0-26.0; the dried apricots—24.0 to 26.0; the dried cranberry—12.0 to 14.0; the honey being the rest to 100%.

The Invention relates to the food-processing industry, namely to the confectionery industry in the field of glazed confectionery products used as quality high-calorific and tonic food for sportsmen, cosmonauts, tourists, and also is recommended for children since it does not contain synthetic products.

Known in the art is a method for production of a filler for confectionery products (RF patent 10 2236791, IPC A23G 3/00, 2004) which provides mixing honey, citric acid and a vegetative component. This method consists in that before mixing the citric acid with others components, it is dissolved in water while adding sugar, syrup and structure-forming agent in the form of pectin in an amount of about 1% by weight, or carboxymethyl cellulose in an amount of about 0.5% by weight, or modified starch in an amount of about 4% by weight, or natural gum in an amount of about 0.3% by weight, or their mixture calculated as an equivalent quantity of one of the above substances. In so doing, the structure-forming agent and sugar are added before mixing with the other components at a ratio of the structure-forming agent and sugar near 1:5 by weight, the mixture is dissolved in water and exposing for swelling, then the mixture is boiled out to an amount of dry matter of about 70% by weight, cooled down and a flavorant is added, said vegetative component being scrubbed lemons, grinded dried apricots and roasted nuts. The citric acid is entered into filler in an amount from 2 to 2.54% by weight.

Known in the art is a confectionery product <<ENERGY+>> (RF patent No. 2400099, IPC A23G 3/34, 2010) taken as the closest analog which represents a molded glazed shell containing natural honey, synthetic citric acid and grinded dried apricots, dried prunes and walnut, said components being taken in following ratio in weight percent:

| | |
|---|---|
| walnut | 23.0-27.0 |
| dried prune | 23.0-27.0 |
| dried apricots | 23.0-27.0 |
| citric acid | 1.0-1.5 |
| honey | the rest to 100% |

Such a formulation of the confectionery product <<ENERGY+>> poorly preserves the shape of the product form (candy stick) at a temperature above the room temperature.

The synthetic citric acid has a negative effect on a human organism. The citric acid is added for flavoring the product and it does not contain any bioactive materials, vitamins or microelements and is harmful to the organism since it is produced in a chemical way (2-2-1,2,3-5 propane tricarboxylic acid (C6H8O7)—a crystal substance of white color with a melting point of 153° C., well soluble in water and soluble in ethyl alcohol).

Replacement of the chemical ingredient by a dried cranberry reduces caloric content of the new product due to a low effect of natural acids on languid glycogens. The activity of languid glycogens rises up considerably under the effect of synthetic acids thereon thus increasing the metabolism activity still in the stomach and not in the intestinal tract as it is determined by the natural instincts of the digestive system.

The languid glycogens are a natural product of long satiety of the human organism and, in contrast to active glycogens, they are promptly soaked up in blood increasing the sugar level in human blood thus oppressing the pancreatic gland activity leading to internal diseases, such as diabetes. The synthetic citric acid is particularly harmful for the children's gastroenteric tract.

The aggressive acid medium arising right after the synthetic citric acid hits the gastroenteric tract, causes reflectory reduction of the walls of the gall bladder and bile-excreting liver ducts, at the same time activating the secretory exhaust of the ferment-reducing cells that leads to origination of a dumping syndrome and refluxesophagitis (active bile exhaust into an atypical residence environment) leading to erosive damage of the mucous membrane and the submucosal layer of the upper spaces of the gastroenteric tract, the stomach and duodenum.

Under the effect of the synthetic acids increasing the metabolism still in stomach, in the medium parts of the gastroenteric tract the normal function of digestion is broken and parietal suctions of the villous epithelium of the small intestines is violated leading to dysfunctional dysbacterioses and misbalanced defecation, in turn, considerably reducing the human life quality.

The application in the prior art of citric acid for imparting an acescent taste to the product is a significant disadvantage.

The common features of the closest analog and the invention are as follows. The confectionery products are made in the form of molded shells coated with glaze and containing natural honey, grinded dried apricots, dried prune and walnut.

The technical result of the invention is ecological cleanliness of the confectionery products due to elimination of harmful effect the synthetic citric acid on the human organism since said acid oppresses the pancreas. This technical result is achieved by means of dried cranberries which impart an acescent taste to the product and impregnate it with bioactive materials, vitamins and microelements, reduce the caloric value due to a minimum effect of the natural acids on the languid glycogens and, besides, expand the assortment of high-quality confectionery products.

The absence of sugar reduces the caloric value of the confectionery product, and making the product at a temperature below 38° C. preserves therein bioactive materials, vitamins and specific acescent fruit chocolate taste with a natural honey flavor.

The new formulation of the <<ENERGY+K>> confectionery product well preserves the shape of the product (candy stick) at a temperature above the room temperature.

The positive effects of cranberry on a human organism.

The cranberry is rich with vitamins and microelements: other berries growing in Russia do not contains so much useful bioactive materials, vitamins and microelements as the cranberry of the Russian North.

100 g of cranberry have a caloric value of 17.7 kcal and contain bioactive materials, vitamins and microelements: water—88.9 g, protein—0.5 g, fat—0.2 g, carbohydrates—3.7 g, mono- and disaccharides—3.7 g, edible fibers—3.3 g, organic acids—3.1 g, ash—0.3 g, vitamin A—0.02 mg, vitamin V1—0.02 mg, vitamin B2—0.02 mg, vitamin B6—0.08 mg, vitamin B9-10. mg, vitamin C—150 mg, vitamin PP—0.2 mg, iron—0.6 mg, potassium—1190 mg, calcium—140. mg, magnesium—8.0 mg, sodium—12.0 mg, phosphorus—25 11.0 mg.

The cranberry prevents formation in the blood of bad cholesterol as the main originator of many heart troubles. Regular cranberry consumption protects women from infections of the genitourinary tract. The substances contained in it kill bacteria, guilty of these diseases. The cranberry gas nerve comfort properties.

According to physician's reports, cranberry prevents formation of plaques in the vessels and to formation of blood clots. The experiments have proved that this berry can relieve patients from a powerful microbe—“helicobacter pillory” provoking said decease and stomach cancer. Patients who regularly used cranberry juice for several months have got rid of this pernicious microorganism.

Cranberry contains glucose, fructose, sucrose, sorbitol, organic acids: quinic, citric, benzoic, apple acids; essential oil, carotin, phenolcarbonic acids, tannins, flavonoids, anthocyans, iodine and potassium salts. The berry leaves contain triterpenoids and flavonoids (quercetine, mericetine, hyperin).

Cranberry against ageing.

It has been proved that cranberry contains a great number of antioxidants that is substances capable of neutralizing harmful effect of free radicals in the organism. Polyphenol is a version of vegetative antioxidant which is contained in cranberry in a considerable amount.

It is well known that antioxidants struggle with the first indications of skin ageing, and cranberry is considered an irreplaceable product in the cosmetic industry.

Cranberry against cancer.

Scientists in increasing frequency insist that cranberry should be an obligatory product in preventive measures of cancer diseases. It is considered that berry juice contacting two ferments in a human organism which cause formation of cancer cells actively counteracts against their creation and distribution. Besides, cranberry contains substances which protect DNA and interfere with growth of cancer cells of thick intestines or prostate. The “wonderful berry” contains quercetin—a product that can help to prevent a cancer of the dairy gland and a thick gut.

Cranberry against bladder infections.

People who suffer from urinogenital system disease simply cannot get along without cranberry juice. It has been found that the curative drink does not allow bacteria to be kept on the bladder walls, thus preventing it from infections.

Cranberry against caries.

The curative force of cranberry juice is capable to kill infection not only in the bladder but in the oral cavity as well. It is well known that the dental deposit is the best soil for reproduction of bacteria and other microorganisms resulting in creation of caries and periodontosis. It has been found that just cranberry is capable to neutralize the bacteria in the oral cavity. That is why the Americans have already begun to develop compositions for mouth rinsing with a cranberry solution. The inhabitants of our country have a unique possibility of using cranberry in a natural form.

Cranberry against a gastritis and an ulcer.

It seems that the antibacterial properties of cranberry make it berry number one. The Chinese physicians on the basis of the researches on men have come to a conclusion that the patients using cranberry dishes or drinks based on the miracle-working berry suffer a stomach ulcer very rare. The salutary properties of berry prevent distribution of such bacteria, as hylicobacter pylon which cause a stomach ulcer. The berry action is reduced to activation of special “cranberry” molecules which do not allow bacteria to remain on a stomach mucous membrane thus preventing appearance of the disease.

Cranberry against common cold.

In the folk medicine there is a series of recipes according to which juice fruit is recommended at a fever, cold-related diseases, quinsy, scurvy, raised blood pressure, malaria, stomach and kidneys diseases, and dropsy. Lotions from juice are used at lichen, dry eczema, exudative skin processes, scrofula .

Cranberry for future mothers.

Flavonoids are substances similar by their properties to antioxidants. The cranberry contains a great number of flavonoids which increase the hardness and elasticity of blood vessels and contributes to better uptake of vitamin. That is why cranberry is an irreplaceable product for a future mummy Besides, it is recommend as an excellent polyvitaminic means that is especially good in the beginning of pregnancy as a life berry.

Cranberry for small geniuses.

During pregnancy the expectant mothers must eat cranberry and to obligatory include it into the child's ration, because cranberry is considered as a “clever” product. Again, it is due to antioxidants contained in it. It has been proved that free radicals impart serious harm to a human organism, namely do a hormone cholesterol harmful to the heart and blood vessels, and also are responsible for memory impairment and works of the musculoskeletal system in an older age. That is why a diet with cranberry dishes leads to memory improvement and more balanced work of the musculoskeletal system.

Cranberry as antibiotic.

Recently, perhaps, the most useful property of cranberry has been found that it can serve as an alternative to antibiotics, especially in struggle against E. Coli (microorganisms responsible for a number of human diseases such as infectious disease of kidneys, gastroenteritis, etc.), i.e. the bacteria which have become steady against traditional medicamentous treatment. It is proved that a special group of substances contained in a cranberry drink and cranberry juice is capable to attack E.Coli so that the latter changes the bacterium form, transforming it from a rod into a sphere, changes the structure of the cellular membrane, complicates the process of attachment of a bacterium to epithelium cells and so on. Certainly, all these metamorphoses reduce the viability of pathogenic bacteria and complicate their penetration in the organism tissue.

Cranberry application in medicine.

Extracts from cranberry are used for medical treatment of chronic pyelonephritis, when antibiotics and sulfanilamide preparation are ineffective.

The iron contained in cranberry is perfectly assimilated by the organism and participates in hematogenesis and haemoglobin formation, as well as in respiratory enzyme.

In the folk medicine cranberry is used for reducing elevated blood pressure. A cranberry is prescribed at rheumatic diseases, anemia, inflammation of the urinary tracts.

The use of dried cranberry instead of citric acid provides ecological cleanliness of the new product, and the Applicant is preparing documents for granting a EU certificate.

Cranberry drying technology.

Cranberry berry is manually cleared and deprived of pedicels, washed in a washing machine, dried on sieves to drain the water therefrom, and then dried on mesh trays in a drying chamber at a temperature not higher that 38° C. to humidity of 12-14%.

The consumption of a raw material per production of 1 kg of the dried up product without allowing for the process losses is 8.5 kg of fresh berry.

The confectionery product manufacturing technology according to the invention.

The confectionery ingredients are mixed and produced at a temperature of not higher than 38° C. to preserve the bioactive materials and vitamins of the raw products.

Before mixing the ingredients, the walnut, dried prune and dried apricots are grinded to a size fraction of 1.0 to 1.5 mm; the dried cranberry—to a size fraction of 1.5-2.5 mm

The walnut, dried prune and dried apricots are taken in fractions of 24-26% by weight, the dried cranberry fraction is taken in a fraction of 14-16% by weight, the rest being honey.

Then liquid natural honey is added to the mass of grinded products at a temperature not higher than 38° C. The composition is stirred at room temperature, for example, by means of a mixer to obtain a homogeneous mass of products. Then the obtained homogeneous mass is put in an extruder bunker. Formation of a confectionery product shell (candy stick) is performed by extruding the mass through a draw plate with a required shape of the aperture (rectangular, trapezoid, circular or oval, etc.)

The mass at the extruder outlet is in the form of a stick which is then cut Into a preset size of a confectionery product shell (candy stick). Then the candy sticks are laid on a pallet, coated with chocolate glaze layer 1 to 1.5 mm thick and the glaze is allowed to solidify. The confectionery product is glazed following the Instructions TI No. 02-03-2000.

The manufacturing technology used for making the confectionery product conserves the candy stick shape due to absorption of honey by the dried cranberry whose microbiological characteristics do not change within 90 days at its storage in a cooler at temperature from +2 to +7° C.

The comparative analysis of the invention with the closest analog allows us to draw a conclusion that the claimed formulation (composition) differs from the prior art by inclusion of a new component—dried cranberry, therefore, the claimed invention meets the criterion of “novelty”.

The manufactured experimental batch of the confectionery product <<ENERGY+K>> has confirmed that it meets the <<industrial applicability>> criterion of the invention and the technical result of the invention has been achieved.

The comparison of the invention with the available analogs has shown that the claimed formulation meets the “inventive step” criterion, since the dried cranberry provides a technical result that evidently does not follow from the known technical level.

The claimed invention is illustrated by an example of produced experimental batch of the <<ENERGY+K>> product.

The preparation of a raw material for production is performed according to the active instruction on prevention of contaminants in the finished product, that is 15 TI 03-04-200.0, TI-03-11-2000 and <<Sanitary Rules for Confectionery Industry Enterprises>>.

The mixture consist of the following products: white honey, grinded and dried cranberry with humidity of 12%, size fraction of 1.5 to 2.5 mm, walnut, dried prune and dried apricots with a size fraction of 1.0 to 1 5 mm at the following ratio of the components by weight %:

| | |
|---|---|
| walnut | 25.0 |
| dried prune | 25.0 |
| dried apricots | 25.0 |
| dried cranberry | 15.0 |
| honey | 1.00 |

When manufacturing 5 kilograms of the experimental batch, the confectionery product components were taken in following weight:

| | |
|---|---|
| walnut | 1000 g |
| dried prune | 1000 g |
| dried apricots | 1000 g |
| dried cranberry | 1500 g |
| white honey | 500 g |

Using a meat grinder, the walnut, dried prune and dried apricots are grinded to a size fraction of 1.0 to 1.5 mm, the dried cranberry to a size fractions of 1.5 to 2.5 mm

The grinded mass is added with 500 g of natural white honey at a temperature of 36° C. Then the mixture is stirred by means of a mixer until a homogeneous mass of products is obtained.

Using an extruder, the obtained homogeneous mass is formed as a rectangular column and is cut into candy sticks having rounded longitudinal ribs and a size of 30×20×50 mm. After that the candy sticks are laid on a pallet and coated with chocolate glaze of 1 to 1.5 mm thick according to OST 10-093-87. The glaze is enabled to solidify in a freezer at a temperature of minus 2-3° C. Then the product is packaged and taken away to a finished goods warehouse.

The weight of a single stick of the <<ENERGY+K>> confectionery product is equal 30 g. 166 candy sticks are produced from a mixture of components of 5 kilograms by weight.

The technical result of the invention is attained by production of a pollution-free product. While preserving an acescent taste of the confectionery product, any harm that might effect a human organism by synthetic citric acid is eliminated due to the use of dried cranberry which saturates the product with bioactive substances, vitamins and microelements, reduces its caloric value, as a result—low effect of the natural acids on the languid glycogens and, in addition, expansion of the assortment of high-quality confectionery products. Besides, the candy sticks well preserve their shape at an environmental temperature above the room temperature.

The technical result of the invention is obtained due to the fact that the confectionery product is a molded shell coated with glaze and containing natural honey, grinded dried cranberry, dried apricots, dried prune and walnut.

The components of a homogeneous mass of products are taken in the following ratio, weight %:

| | |
|---|---|
| walnut | 24.0-26.0 |
| dried prune | 24.0-26.0 |
| dried apricots | 24.0-26.0 |
| dried cranberry | 14.0-16.0 |
| honey | the rest to 100% |

The confectionery product <<ENERGY+K>> is used mainly with various hot and cold drinks.

The organoleptic characteristics of the confectionery product <<ENERGY+K>> are given in the Table.

| Parameter | Characteristic |
|---|---|
| Physiological value | Advanced potential and emotional possibilities |
| | of a human organism |
| Edible value | This is provided by all natural products used |
| | without heat treatment |
| Taste and smell | The product has an acescent gentle taste of fruit |
| | and chocolate intensified by taste and smell of |
| | natural honey |
| Surface | A smooth surface of a chocolate glaze, the |
| | chocolate layer having a uniform thickness |
| Color | The color corresponds to that of the chocolate |
| | glaze |
| Structure and consistence | A soft, gentle structure, the stick can be broken |
| | into several pieces if desirable. |

The confectionery product according to the invention contributes to recovery of hemoglobin, iron, blood erythrocytes, improves the brain activity, memory, concentration of attention, thinking; increases the content of prostaglandins, humoral and cellular immunity, promotes potentiality and biological activity; increases life tonus of organs and systems of an organism, skin tightness and cellular nourishing.

The product is made without sugar for reducing its caloric value and without thermal treatment for preserving the bioactive materials and vitamins in the finished product that has an acescent berrylike-chocolate taste with smell and taste of honey, while keeping its shape at summer temperature.

In the claims:

1. A confectionery product consisting of a molded glazed shell containing natural honey, grinded dried apricots, dried prune, walnut, characterized in that it includes dried cranberry and components of a homogeneous mass of products taken in the following ratio, percentage by weight:

| | |
|---|---|
| walnut | 24.0-26.0 |
| dried prune | 24.0-26.0 |
| dried apricots | 24.0-26.0 |
| dried cranberry | 12.0-14.0 |
| walnut honey | the rest to 100% |

2. The confectionery product as claimed in claim 1, characterized in that the dried cranberry is grinded to a size fraction of 1.5-2.5 mm.
